(19) United States
(12) Patent Application Publication
(10) Pub. No.: US 2026/0148038 A1
(43) Pub. Date: May 28, 2026

(54) INFORMATION PROPAGATION PREDICTION METHOD BASED ON SEQUENTIAL HYPERGRAPH NEURAL NETWORK WITH CO-ATTENTION FUSION

(71) Applicants: Nanjing University of Aeronautics and Astronautics, Jiangsu (CN); Zhejiang Lab, Zhejiang (CN); Zhengzhou University of Aeronautics, Henan (CN)

(72) Inventors: Ye LU, Jiangsu (CN); Ji ZHANG, Jiangsu (CN); Ting YU, Zhejiang (CN); Fei GE, Jiangsu (CN); Jianhui CHEN, Henan (CN)

(73) Assignees: Nanjing University of Aeronautics and Astronautics, Jiangsu (CN); Zhejiang Lab, Zhejiang (CN); Zhengzhou University of Aeronautics, Henan (CN)

(21) Appl. No.: 19/178,917

(22) Filed: Apr. 15, 2025

(30) Foreign Application Priority Data
Apr. 16, 2024 (CN) 202410454425.3

(51) Int. Cl. G06N 3/042; G06N 3/08

(52) U.S. Cl. CPC G06N 3/042; G06N 3/08

(57) ABSTRACT

An information propagation prediction method based on a sequential hypergraph neural network with co-attention fusion. The method includes three modules: a user feature learning module learning a user embedding by utilizing a graph convolutional neural network; a cascade feature learning module constructing a sequential hypergraph neural network based on equivariant diffusion to capture a complex cascade irregular connection so as to learn a cascade embedding of internal and external features of an encapsulated cascade structure; and a feature fusion and prediction module learning an interdependence between cascade features and user features by means of a co-attention mechanism so as to capture a complex relationship and interaction between the cascade features and the user features, and then calculating a possibility of potential user infection. The present disclosure achieves more effective information propagation prediction, comprehensively considers the external influence of other cascades, and combines a novel feature fusion technology.

### CROSS-REFERENCE TO RELATED APPLICATION

This application claims the priority benefit of China application serial no. 202410454425.3, filed on Apr. 16, 2024. The entirety of the above-mentioned patent application is hereby incorporated by reference herein and made a part of this specification.

### BACKGROUND

### Technical Field

The present disclosure relates to the field of deep learning and information propagation prediction, in particular, to an information propagation prediction method based on a sequential hypergraph neural network with co-attention fusion.

### Description of Related Art

Information propagation prediction is an important research direction in the field of social network analysis, and by using factors such as cascade propagation relations and user features, the information propagation prediction is used for researching how information is propagated among users and predicting users who forward messages next. With the wide application of social media platforms, the information propagation mechanism is increasingly complex, which has a far-reaching impact on the formulation of social marketing strategies, the identification of false information and the guidance of public opinion.

Currently, information propagation prediction methods can be roughly divided into two categories, namely methods based on feature engineering and methods based on deep learning. An effective prediction model is designed by analyzing factors such as a topological structure, a user behavior pattern and information content of a social network based on a feature engineering method. Such methods, while providing some degree of interpretable prediction results, often require significant human involvement and domain knowledge support, and have limitations in processing large-scale data and complex network structures. In recent years, with the rapid development of artificial intelligence technology, methods based on deep learning are beginning to be widely applied in the field of information propagation prediction. These methods utilize the powerful representation learning ability of the neural network, and automatically extract and learn complex features in the data, thus avoiding complicated feature engineering. In particular, technologies such as graph neural networks, recursive neural networks, and attention mechanisms have proven to be particularly advantageous in simulating information propagation dynamics in social networks. In addition, emerging technologies such as the hypergraph neural network provide new possibilities for processing high-order complex relationships in social networks. The hypergraph neural network expands the neural network to a hypergraph structure, which can process irregular data that cannot be represented as grids but can be represented as graphs, can better simulate high-order relationships and group behaviors among users, and has important significance for improving the accuracy of information propagation prediction.

The existing deep learning-based methods mainly focus on mining social influence and group homogeneity features of early infected users from social network structures and historical cascade events, which often ignores the influence of external factors in the process of information propagation. Secondly, when the current model integrates cascade representation and user preference, features tend to be directly fused, which ignores potential relevance among the features, possibly causing information redundancy, and thus reducing prediction accuracy and generalization capability of the model. Therefore, there is a need in the field of information propagation prediction for a more efficient model to address these challenges.

The existing methods in the field of information propagation prediction usually ignore the influence of external information in the information propagation process, and the fusion of feature information is too simple and direct. The actual social network environment is full of many parallel information diffusion flows, among which not only the propagation mechanism inside a single information flow is complex and changeable, but also the cross-propagation between different information flows has many interactions and influences. Therefore, it is very important to characterize these external factors and their influences on the information diffusion process, especially in the aspect of modeling the cascade relationship. Secondly, when the current model integrates cascade representation and user preference, direct fusion is carried out, which ignores potential relevance among the features, possibly causing information redundancy, and thus reducing prediction accuracy and generalization capability of the model. Based on the two points, the present disclosure constructs a sequential hypergraph neural network based on equivariant diffusion, regards propagation of each piece of information as a hyperedge, and learns the correlation between the hyperedges. Moreover, combined with a co-attention mechanism based on stacking a plurality of co-attention layers, an interdependence between cascade features and user features is learned to capture a complex relationship and interaction between the cascade features and the user features.

### SUMMARY

Objective of the present disclosure: the present disclosure provides an information propagation prediction method based on a sequential hypergraph neural network with co-attention fusion, so as to solve the above problems of the prior art.

Technical solutions: provided is an information propagation prediction method based on a sequential hypergraph neural network with co-attention fusion, which includes the following steps:
S1, user feature learning
constructing a social network graph according to known information concerned by user batches, and learning embedding representations of users by using a dual-layer graph convolutional network to finally obtain static representations

$${X}_{F}^{{L}_{F}}$$

of all the users in consideration of a relatively stable structure of a social network of the users;
S2, cascade feature learning
constructing a propagation cascade graph by adopting a hypergraph, regarding propagation of each piece of information as a hyperedge, considering the characteristic that influences among the information are generally short-term correlation, decomposing previous cascades into a plurality of subsets based on timestamps, constructing a hypergraph according to each subset, acquiring a cascade embedding of each subset by using a hypergraph neural network based on equivariant diffusion, and connecting cascade embeddings of different timestamps by means of a gated residual mechanism; and
S3, feature fusion and prediction
firstly, aligning a time

$${t}_{i}^{m}$$

when a user uᵢ propagates the information with a pre-stored timestamp, then retrieving the relevant cascade embedding to obtain C_{D}=[(h_{e,t})]∈ [symbol] ^{|c}^{ₘ}^{|×d}, t=1, 2, . . . , T, wherein h_{e,t} represents the cascade embeddings obtained at different timestamps in S2, then stacking two co-attention layers, and learning an interdependence between cascade features and user features by means of a co-attention mechanism, so as to capture a complex relationship and interaction between the cascade features and the user features, and then calculating a possibility of potential user infection.

Further, in the user feature learning, a layer-by-layer propagation rule of the graph convolutional network is as follows:

$${X}_{F}^{l + 1} = σ ( {\tilde{{D}_{f}}}^{- \frac{1}{2}} \tilde{{A}_{f}} {\tilde{{D}_{f}}}^{- \frac{1}{2}} {X}_{F}^{l} {W}_{F} )$$

wherein, W_{F} is a trainable weight matrix, and [symbol] =A_{F}+I and [symbol] are an adjacency matrix and a degree matrix of a self-loop social network graph G_{F}, respectively.

Further, S2 includes constructing the hypergraph neural network based on equivariant diffusion, specifically including:
(1) Node to Hyperedge
for each node on the hypergraph, firstly, transforming a node feature of the node by means of a multilayer perceptron, and then gathering the node feature to an associated hyperedge to obtain a hyperedge representation

$${m}_{e}^{l + 1} ,$$

and a specific form is as follows:

$${m}_{u \to e}^{l + 1} = \hat{ϕ} ( {h}_{v , t}^{l} ) \\ {m}_{e}^{l + 1} = {Σ}_{u ∈ e} {m}_{u \to e}^{l + 1}$$

wherein, \hat{φ} is the multilayer perceptron, the multilayer perceptron in the model shares parameters,

$${h}_{v , t}^{l}$$

is the node feature, and

$${h}_{v , t}^{0} = {X}_{F}^{{L}_{F}}$$

is an initial feature;
(2) Hyperedge to node
broadcasting the hyperedge representation

$${m}_{e}^{l + 1}$$

to the related node, and calculating information

$${m}_{e \to u}^{l + 1}$$

from the hyperedge to the node by means of a multilayer perceptron, a specific form being as follows, wherein p is the multilayer perceptron:

$${m}_{e \to u}^{l + 1} = \hat{p} ( {h}_{v , t}^{l} , {m}_{e}^{l + 1} )$$

(3) Node feature updating for each node on the hypergraph, updating a feature

$${h}_{v , t}^{l + 1}$$

of the node by using a multilayer perceptron, and a specific form is as follows:

$${h}_{v , t}^{l + 1} = \hat{φ} ( {h}_{v , t}^{1} , {Σ}_{e : u ∈ e} {m}_{e \to u}^{l + 1} , {X}_{F}^{{L}_{F}} , {d}_{v} )$$

wherein, \hat{φ} is the multilayer perceptron, and dᵥ represents degree information of the node;
(4) Hyperedge feature updating
for each hyperedge, aggregating the updated node feature into the hyperedge, and then updating a hyperedge feature

$${h}_{e , t}^{l + 1}$$

by using a multilayer perceptron \hat{ψ}, and a specific form is as follows:

$${h}_{e ,}^{l + 1} = \hat{ψ} ( {Σ}_{u : e ∈ u} {h}_{v , t}^{l + 1} ) .$$

In addition, S2 includes introducing the gated residual mechanism to achieve propagation of residual information between different timestamps, and the mechanism generates an initial embedding of each node by combining a dynamic embedding and a user embedding of the node for each time period, including the following calculation:
the initial embedding of the node at a timestamp t+1 can be calculated as follows:

$${h}_{v , t + 1}^{0} = {gh}_{v , t}^{{L}_{D}} + ( 1 - g ) {X}_{F}^{{L}_{F}} , g = \frac{{e}^{{z}_{R}^{T} σ ( {W}_{R} {h}_{v , t}^{{L}_{D}} )}}{{e}^{{z}_{R}^{T} σ ( {W}_{R} {h}_{v , t}^{{L}_{D}} )} + {e}^{{z}_{R}^{T} σ ( {W}_{R} {X}_{F}^{{L}_{F}} )}}$$

wherein, W_{R} and z_{R} represent a transformation matrix and a vector of the gating mechanism, respectively, σ(·) represents a tanh function, a user representation

$${X}_{F}^{{L}_{F}}$$

learned from a user feature learning module is used as an initial embedding of the user,

$${h}_{v , t}^{{L}_{D}}$$

represents a hypergraph node feature obtained by the hypergraph neural network based on equivariant diffusion, and a value g calculated by a gating function is used to control a percentage of the residual information retained, and the hypergraphs are sequentially connected by the gated residual mechanism.

Further, the feature fusion in S3 is progressive, with an output of each layer being used as an input of the next layer; in a first co-attention layer, a user embedding

$${X}_{F}^{{L}_{F}}$$

and a cascade embedding C_{D} are combined to generate a fusion embedding

$${R}_{CA}^{( 1 )} ;$$

then, in a second co-attention layer, C_{D} and

$${R}_{CA}^{( 1 )}$$

are combined to generate a final fusion embedding R_{CA} to further enhance the fusion; an output vector of each co-attention layer is d-dimensional;
the following is a calculation process for the first co-attention layer:

$${R}_{{CA}_{X ← C}} = {X}_{F}^{{L}_{F}} + MA ( {X}_{F}^{{L}_{F}} , {C}_{D} , {C}_{D} )$$

$${R}_{{CA}_{X ← C}^{′}} = {R}_{{CA}_{X ← C}} + FFN ( {R}_{{CA}_{X ← C}} ) )$$

$${R}_{{CA}_{C ← X}} = {C}_{D} + MA ( {C}_{D} , {X}_{F}^{{L}_{F}} , {X}_{F}^{{L}_{F}} )$$

$${R}_{{CA}_{C ← X}^{′}} = {R}_{{CA}_{C ← X}} + FFN ( {R}_{{CA}_{C ← X}} )$$

$${R}_{CA}^{( 1 )} = ( {R}_{{CA}_{X ← C}^{′}} ⊕ {R}_{{CA}_{C ← X}^{′}} ) {W}_{CA}^{( 1 )}$$

R_{CA}_{_{X←C}} represents a result of the user embedding after being processed by the co-attention mechanism, and MA represents the attention mechanism considering the influence of the cascade embedding C_{D} in the user embedding

$${X}_{F}^{{L}_{F}} \cdot {R}_{{CA}_{X ← C}^{′}}$$

is a result of applying a feedforward neural network to an output of R_{CA}_{_{X←C}}, and FFN is the feedforward neural network used to enhance nonlinearity and capability to capture complex modes. R_{CA}_{_{X←C}} represents a result of the cascade embedding after being processed by the co-attention mechanism considering the influence of the user embedding

$${X}_{F}^{{L}_{F}}$$

in the cascade embedding C_{D}. R_{CA′}_{_{X←C}} is a result of applying a feedforward neural network to an output of

$${R}_{{CA}_{C ← X}} \cdot {R}_{CA}^{( 1 )}$$

is a final output of the first co-attention layer and will be passed to the next co-attention layer.

$${W}_{CA}^{( 1 )}$$

∈ [symbol] ^{2d×d} is a projection matrix of the first co-attention layer, ⊕ represents the concatenation of vectors, and

$${R}_{CA}^{( 1 )}$$

is converted into a d+1-dimensional representation before being input to the next CA layer.

Further, the feature fusion and prediction in S3 include calculating a diffusion probability of the users by means of the following method:

$$\hat{y} = soft max ( {W}_{p} {R}_{CA} + {Mask}_{m} )$$

wherein, Wₚ is a transformation matrix that maps R_{CA} to a user-specific space, and Maskₘ is used to mask the users that have been activated before the prediction.

By combining the implementation of the above method, the method is constructed with a user feature learning module, a cascade feature learning module, and a feature fusion and prediction module, which are specifically as follows:
a user feature learning module acquiring a user embedding by using a graph convolutional neural network;
a cascade feature learning module configured to acquire a cascade embedding of internal and external features of an encapsulated cascade structure; and
a feature fusion and prediction module acquiring fusion features of the cascade embedding and the user embedding by using a cascade embedding query process and a dual-layer co-attention mechanism and then calculating a possibility of potential user propagation.

The feature fusion and prediction module in the method includes a feature fusion layer and propagation prediction, wherein the feature fusion layer includes the cascade embedding query process and the dual-layer co-attention mechanism, and information leakage is avoided by carefully selecting a pre-engagement embedding; the co-attention layer has user-to-cascade and cascade-to-user attention flows, achieves fine integration of user preference and cascade dynamics, and utilizes an interdependence between the user preference and the cascade dynamics to enhance a prediction capability of the model.

Further, in the cascade embedding query process, for a given target cascade, a representation of the cascade is read in a latest time interval before the user participates in the cascade, so as to reduce a risk of information leakage, and the process needs to align the time tᵢ^{m} when the user uᵢ propagates the information with the pre-stored timestamp, and then the relevant cascade embedding is retrieved to obtain C_{D}=[(h_{e,t})]∈R^{|c}^{ₘ}^{|×d},t=1, 2, . . . , T, wherein h_{e,t} represents the cascade embeddings obtained at different timestamps in S2;
a co-attention block is operated by utilizing queries from one modality and keys and values from another modality, and a query matrix serves as residual information after a multi-head attention sublayer.

Beneficial effects: The present disclosure achieves more effective information propagation prediction, comprehensively considers the external influence of other cascades, and combines a novel feature fusion technology based on stacking a plurality of co-attention layers, thereby improving the prediction capability of information diffusion.

### BRIEF DESCRIPTION OF THE DRAWINGS

FIG. 1 is a framework diagram of a sequential hypergraph neural network based on co-attention fusion;

FIG. 2 is a diagram of co-attention blocks;

FIG. 3A-FIG. 3D show the experimental results of comparative experiments on four datasets with different training ratios according to the present disclosure, wherein: FIG. 3A corresponds to a Twitter dataset, FIG. 3B corresponds to a Douban dataset, FIG. 3C corresponds to an Android dataset, and FIG. 3D corresponds to a Christianity dataset.

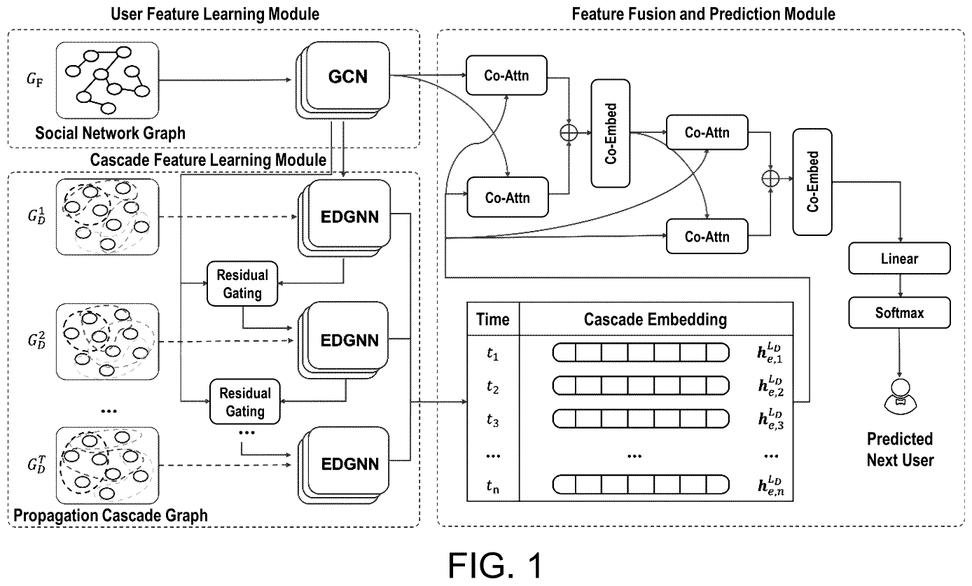

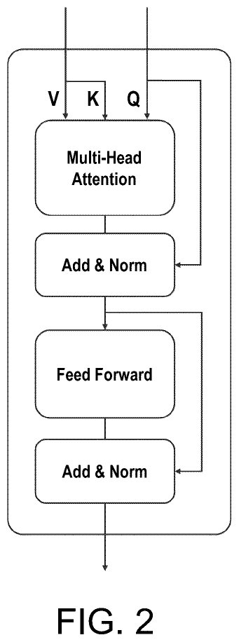

### DESCRIPTION OF THE EMBODIMENTS

In order to explain the technical solutions provided by the present disclosure in detail, the following description is further introduced with reference to the attached drawings of the specification.

Disclosed is an information propagation prediction method based on a sequential hypergraph neural network with co-attention fusion, which is used for predicting information propagation. The method includes:
a user feature learning module learning a user embedding by using a graph convolutional neural network;
a cascade feature learning module constructing a sequential hypergraph neural network based on equivariant diffusion to capture a complex cascade irregular connection so as to learn a cascade embedding of internal and external features of an encapsulated cascade structure; and
a feature fusion and prediction module learning an interdependence between cascade features and user features by means of a co-attention mechanism, so as to capture a complex relationship and interaction between the cascade features and the user features, and then calculating a possibility of potential user infection.

The present disclosure achieves more effective information propagation prediction, comprehensively considers the external influence of other cascades, and combines a novel feature fusion technology based on stacking a plurality of co-attention layers, thereby improving the prediction capability of information diffusion.

Specifically, the method of the present disclosure may be implemented as follows.

Provided is an information propagation prediction method based on a sequential hypergraph neural network with co-attention fusion, which includes the following steps:

### S1, User Feature Learning (User Feature Learning Module)

A social network graph is constructed according to known information concerned by user batches, and embedding representations of users are learned by using a dual-layer graph convolutional network to obtain static representations

$${X}_{F}^{{L}_{F}}$$

of all the users in consideration of a relatively stable structure of a social network of the users;
in particular, embedding representations of users are learned by using a dual-layer graph convolutional network to finally obtain static representations

$${X}_{F}^{{L}_{F}}$$

of all the users.

The layer-by-layer propagation rule of the graph convolutional network is as follows:

$${X}_{F}^{l + 1} = σ ( {\tilde{{D}_{F}}}^{- \frac{1}{2}} \tilde{{A}_{F}} {\tilde{{D}_{F}}}^{- \frac{1}{2}} {X}_{F}^{l} {W}_{F} )$$

wherein, W_{F} is a trainable weight matrix, and [symbol] =A_{F}+I and [symbol] are an adjacency matrix and a degree matrix of a self-loop social network graph G_{F}, respectively.

### S2, Cascade Feature Learning (Cascade Feature Learning Module)

A propagation cascade graph is constructed by adopting a hypergraph, propagation of each piece of information is regarded as a hyperedge, by considering the characteristic that influences among the information are generally short-term correlation, previous cascades are decomposed into a plurality of subsets based on timestamps, a hypergraph is constructed according to each subset, a cascade embedding of each subset is acquired by using a hypergraph neural network based on equivariant diffusion, and cascade embeddings of different timestamps are connected by means of a gated residual mechanism;
the implementation steps of the hypergraph neural network based on equivariant diffusion and the gated residual mechanism will be described in detail below.

Hypergraph neural network based on equivariant diffusion

### (1) Node to Hyperedge

In this step, for each node on the hypergraph, a node feature thereof is firstly transformed by a multilayer perceptron. Then, the node feature is gathered to an associated hyperedge to obtain a hyperedge representation

$${m}_{e}^{l + 1} ,$$

and the specific form is as follows:

$${m}_{u \to e}^{l + 1} = \hat{ϕ} ( {h}_{v , t}^{l} )$$

$${m}_{e}^{l + 1} = {\sum }_{u ∈ e} {m}_{u \to e}^{l + 1}$$

wherein, \hat{φ} is the multilayer perceptron, and the multilayer perceptron in the model shares parameters.

$${h}_{v , t}^{l}$$

is the node feature, and

$${h}_{v , t}^{0} = {X}_{F}^{{L}_{F}}$$

is an initial feature.

### (2) Hyperedge to Node

This step achieves equivariance. broadcasting the hyperedge representation

$${m}_{e}^{l + 1}$$

to the related node, and calculating information

$${m}_{e \to u}^{l + 1}$$

from the hyperedge to the node by means of a multilayer perceptron, a specific form being as follows, wherein \hat{ρ} is the multilayer perceptron:

$${m}_{e \to u}^{l + I} = \hat{ρ} ( {h}_{v , t}^{l} , {m}_{e}^{l + 1} )$$

### (3) Node Feature Updating

For each node on the hypergraph, a node feature

$${h}_{v , t}^{l + 1}$$

is updated by using a multilayer perceptron according to the node feature, the information from the hyperedge to the node, the input feature of the node, and the degree information of the node, and the specific form is as follows:

$${h}_{v , t}^{l + 1} = \hat{φ} ( {h}_{v , t}^{l} , {\sum }_{e : u ∈ e} {m}_{e \to u}^{l + 1} , {X}_{{F}^{h}}^{{L}_{F}} , {d}_{v} )$$

wherein, \hat{φ} is the multilayer perceptron, and dᵥ represents the degree information of the node.

### (4) Hyperedge Feature Updating

For each hyperedge, the updated node feature is aggregated into the hyperedge, and then a hyperedge feature

$${h}_{e , t}^{l + 1}$$

is updated by using a multilayer perceptron \hat{ψ}, and the specific form is as follows:

$${h}_{e , t}^{l + 1} = \hat{ψ} ( {\sum }_{u : e ∈ u} {h}_{v , t}^{l + 1} )$$

wherein, \hat{φ} and \hat{ψ} are both the multilayer perceptrons, here for the convenience of different representation and calculation of the layers.

### (5) Gated Residual Mechanism

To propagate the residual information between different timestamps, the present disclosure introduces a gated residual mechanism. The mechanism generates an initial embedding of each node by combining a dynamic embedding and a user embedding of the node for each time period. The initial embedding of the node at a timestamp t+1 can be calculated as follows:

$${h}_{v , t + 1}^{0} = g {h}_{v , t}^{{L}_{D}} + ( 1 - g ) {X}_{F}^{{L}_{F}} , g = \frac{{e}^{{z}_{R}^{T} σ ( {W}_{R} {h}_{v , t}^{{L}_{D}} )}}{{e}^{{z}_{R}^{T} σ ( {W}_{R} {h}_{v , t}^{{L}_{D}} )} + {e}^{{z}_{R}^{T} σ ( {w}_{R} {x}_{F}^{{L}_{F}} )}}$$

wherein, W_{R} and z_{R} represent a transformation matrix and a vector of the gating mechanism, respectively, and σ(·) represents a tanh function. A user representation

$${x}_{F}^{{L}_{F}}$$

learned from a user feature learning module is used as an initial embedding of the user, and

$${h}_{v , t}^{{L}_{D}}$$

represents a hypergraph node feature obtained by the hypergraph neural network based on equivariant diffusion. A value g calculated by a gating function is used to control a percentage of the residual information retained. The hypergraphs are sequentially connected by the gated residual mechanism.

S3, feature fusion and prediction (feature fusion and prediction module)

Firstly, a time

$${t}_{i}^{m}$$

when a user uᵢ propagates the information is aligned with a pre-stored timestamp, then the relevant cascade embedding is retrieved to obtain C_{D}=[(h_{e,t})]∈ [symbol] ^{|c}^{ₘ}^{|×d}, t=1, 2, . . . , T, wherein h_{e,t} is the cascade embeddings obtained at different timestamps in S2, then two co-attention layers are stacked, and an interdependence between cascade features and user features is learned by means of a co-attention mechanism, so as to capture a complex relationship and interaction between the cascade features and the user features, and then a possibility of potential user infection is calculated.

The module includes a feature fusion layer and propagation prediction, and the specific implementation of each part is described below.

### (1) Feature Fusion Layer

The feature fusion layer includes a cascade embedding query process and a dual-layer co-attention mechanism. This design avoids information leakage by carefully selecting a pre-engagement embedding. The co-attention layer has user-to-cascade and cascade-to-user attention flows, achieves fine integration of user preference and cascade dynamics, and effectively utilizes an interdependence between the user preference and the cascade dynamics to enhance the prediction capability of the model.

### (2) Cascade Embedding Query

To emphasize the captured interactions in the cascades, the present disclosure implements a cascade embedding query mechanism. Unlike the embedding method using only the last active cascade, the present disclosure reads the embeddings of all active cascades to represent the target cascade. In particular, for a given target cascade, the representation of the cascade is read in the latest time interval before the user participates in the cascade, so as to reduce the risk of information leakage. The process needs to align the time

$${t}_{i}^{m}$$

when the user uᵢ propagates the information with the pre-stored timestamp, and then the relevant cascade embedding is retrieved to obtain C_{D}=[(h_{e,t})]∈ [symbol] ^{|c}^{_{m|×d}}, t=1, 2, . . . , T, wherein h_{e,t} represents the cascade embeddings obtained at different timestamps in S2.

### 1) Co-Attention Mechanism

A co-attention block is operated by utilizing queries from one modality and keys and values from another modality. A query matrix serves as residual information after a multi-head attention sublayer. When queries (Q) originate from users, and keys (K) and values (V) come from cascades, the attention values calculated using the queries and keys can measure the similarity between the users and the cascades. Thus, the cascades are weighted accordingly, thereby enabling a more precise focus on the user area associated with the cascades, and understanding the interdependence between various cascade embeddings and user embeddings.

The co-attention layer connects two co-attention blocks in parallel, each of which is tasked with processing a different set of features. Each co-attention block separately calculates a query, a key, and a value. Subsequently, the key and values from one co-attention block are provided as inputs to the other block, thereby achieving an exchange of information between two blocks. The outputs of two co-attention blocks are concatenated and processed by a fully connected layer to produce a fused representation. This layer effectively simulates intensive interactions between different modalities by facilitating information exchange.

To achieve deep integration of user features and cascade features, the present disclosure stacks two co-attention layers. This fusion process is progressive, with an output of each layer being used as an input of the next layer. For example, in a first co-attention layer, a user embedding

$${X}_{F}^{{L}_{F}}$$

and a cascade embedding C_{D} are combined to generate a fusion embedding

$${R}_{C A}^{( 1 )} .$$

Then, in a second co-attention layer, C_{D} and

$${R}_{C A}^{( 1 )}$$

are combined to generate a final fusion embedding R_{CA} to further enhance the fusion. An output vector of each co-attention layer is d-dimensional.

The following is a calculation process for the first co-attention layer:

$${R}_{C {A}_{X ← C}} = {X}_{F}^{{L}_{F}} + M A ( {X}_{F}^{{L}_{F}} , {C}_{D} , {C}_{D} ) \\ {R}_{{CA}_{X ← C}^{′}} = {R}_{C {A}_{X ← C}} + F F N ( {R}_{C {A}_{X ← C}} ) ) \\ {R}_{C {A}_{C ← X}} = {C}_{D} + M A ( {C}_{D} , {X}_{F}^{{L}_{F}} , {X}_{F}^{{L}_{F}} ) \\ {R}_{C {A}_{C ← X}^{′}} = {R}_{C {A}_{C ← X}} + F F N ( {R}_{C {A}_{C ← X}} ) \\ {R}_{C A}^{( 1 )} = ( {R}_{C {A}_{X ← C}^{′}} ⊕ {R}_{C {A}_{C ← X}^{′}} ) {W}_{C A}^{( 1 )}$$

R_{CA}_{_{X←C}} represents a result of the user embedding after being processed by the co-attention mechanism, and MA represents the attention mechanism considering the influence of the cascade embedding C_{D} in the user embedding

$${X}_{F}^{{L}_{F}} \cdot {R}_{C {A}_{X ← C}^{′}}$$

a result of applying a feedforward neural network to an output of R_{CA}_{_{X←C}}, and FFN is the feedforward neural network used to enhance nonlinearity and capability to capture complex modes. R_{CA}_{_{X←C}} represents a result of the cascade embedding after being processed by the co-attention mechanism considering the influence of the user embedding

$${X}_{F}^{{L}_{F}}$$

in the cascade embedding C_{D}. R_{CA′}_{_{X←C}} is a result of applying a feedforward neural network to an output of

$${R}_{C {A}_{C ← X}} \cdot {R}_{C A}^{( 1 )}$$

is a final output of the first co-attention layer and will be passed to the next co-attention layer.

$${W}_{C A}^{( 1 )}$$

∈ [symbol] ^{2d×d} is a projection matrix of the first co-attention layer, ⊕ represents the concatenation of vectors, and

$${R}_{C A}^{( 1 )}$$

is converted into a d+1-dimensional representation before being input to the next CA layer.

### 2) Propagation Prediction

The present disclosure calculates a diffusion probability of the users by means of the following method:

$$\hat{y} = softmax ( {W}_{p} {R}_{C A} + {Mask}_{m} )$$

wherein, Wₚ is a transformation matrix that maps R_{CA} to a user-specific space, Maskₘ is used to mask the users that have been activated before the prediction, if the user uᵢ participates in a cascade cₘ in a step j, then

$${( {Mask}_{m} )}_{1 , i}^{j , i} = 0 , {and ( {Mask}_{m} )}_{j + 1 , i}^{\vert {c}_{m} \vert , i} = - ∞ .$$

Training is carried out by adopting cross-entropy loss:

$$𝒥 ( θ ) = - {Σ}_{j = 2}^{\vert {c}_{m} \vert} {Σ}_{i = 1}^{\vert U \vert} {y}_{ji} log ( {\hat{y}}_{j i} )$$

wherein, θ represents all parameters that need to be learned in the model, and if the user uᵢ participates in the cascade cₘ in the step j, then yⱼᵢ=1, or otherwise, yⱼᵢ=0.

The technical effect of the present disclosure is further verified through experiments.

The present disclosure was implemented in PyTorch 2.1.2 on NVIDIA GeForce RTX 4060 GPU. For all datasets, a training set, a validation set, and a test set were partitioned in 8:1:1. The model was optimized using Adam optimizer and the learning rate was set to 0.001. The Dropout rate was set to 0.3. The batch size was set to 64 and the embedded size was also set to 64. The number of layers of three MLPs in the model was set to 1, and the hidden dimension was 128; the number of layers of a classifier was set to 2, and the hidden dimension was 96. The depth of the co-attention layer was 2. After experimental verification, the Twitter and Douban datasets were finally divided into 8 time blocks; the Android and Christianity datasets were divided into 3 time blocks. For a baseline model, the settings provided in the original model were retained.

In order to verify the universality and effectiveness of the model, experiments were carried out in four different application scenes, namely the Twitter and Douban datasets, as well as datasets from question-and-answer websites, namely the Android and Christianity datasets. The detailed summary of the datasets is shown in Table 1.

TABLE 1
Specific information of datasets

| Dataset | User | Connection | Cascade | Average length |
|---|---|---|---|---|
| Twitter | 12627 | 309631 | 3442 | 32.60 |
| Douban | 12232 | 396580 | 3475 | 21.76 |
| Android | 9958 | 48573 | 679 | 33.3 |
| Christianity | 2897 | 35624 | 589 | 22.9 |

Twitter: the propagation path and timestamps of tweets published on Twitter in October 2010 were extracted, and a social relationship network was created according to the attention relationship.

Douban: data were mainly extracted from books that users share on Douban, and if users participate in the same discussion more than 20 times, they are considered friends, and thus a social relationship network was constructed.

Android: data mainly came from question-answer interactions on StackExchange, including user questions, answers and other interactions. These interactions constitute a network of social relationships between users.

Christianity: data mainly came from question-answer interactions on StackExchange, centered on Christian themes. These interactions form cascades and constitute a social relationship network among users. The information propagation prediction was taken as a retrieval task, propagation probability prediction was carried out on all candidate users to obtain a candidate set, and ranking was carried out according to the prediction probability. Therefore, Hits@K and Map@K were selected as evaluation indexes in the present disclosure.

1) Hits@K: the infection probability ratio associated with the top K users ranked who were actually infected.

2) Map @K: the existence of actual users and particular ranking positions thereof in the ranking prediction result were considered to evaluate the specific ranking of

$${u}_{j}^{m} .$$

This model was compared with several classical information propagation prediction methods, including:

DeepDiffuse: with a recursive neural network and an attention mechanism, users who are likely to be infected in the social network and the time of infection are predicted based on the timestamp data.

Topo-LSTM: aims to enhance the propagation model by considering the social relationship between users, and extends the standard LSTM model.

NDM: a microcosmic cascade model is established based on the relaxation hypothesis, and an attention mechanism and a convolutional neural network are combined to alleviate the long-term dependence problem.

SNIDSA: a structural attention module is defined to introduce structural features, followed by modeling and prediction of propagation using a recursive neural network.

FOREST: multi-scale propagation is predicted from both micro and macro perspectives, and a novel recursive neural network-based context extraction algorithm is employed to better utilize user information embedded in a social network graph.

Inf-VAE: based on user social relationships, a graph neural network is used to selectively utilize social variables and a novel fusion network is designed to learn social and temporal variables.

DyHGCN: a heterogeneous graph is constructed based on user attention and forwarding relationships, and then a graph convolutional network is used to learn user representations.

MSHGAT: a sequential hypergraph attention network with enhanced memory is used to dynamically capture user preferences, which are integrated with user's social graph representation.

Tables 2, 3, 4 and 5 show the combined performance of this model and the baseline model. It is clear from the results that this model is significantly superior to the existing baseline model in terms of prediction performance. Compared with other models, this model captures internal and external influences of the cascades by utilizing the hypergraphs, and introduces a co-attention mechanism to effectively fuse user embeddings and cascade embeddings, thus reducing redundancy. Therefore, on the Twitter and Douban datasets with rich cascade information, this model comprehensively captures the cascade information and performs better in the aspect of feature fusion. Compared with the most advanced model, Hits@100 is increased by 16%, and MAP@100 is increased by 18%. In addition, on the Android and Christianity datasets with less cascade information, this model also shows improvement, namely Hits @100 is increased by 2%, and MAP@100 is increased by 1%. This shows that this model performs well in dealing with complex information propagation scenarios and also maintains good performance in scenarios where cascade propagation is relatively simple.

TABLE 2
Experimental results on the Twitter dataset

| | Twitter | | | | | |
|---|---|---|---|---|---|---|
| Model | Hits@ 10 | Hits@ 50 | Hits@ 100 | MAP@ 10 | MAP@ 50 | MAP@ 100 |
| DeepDiffuse | 5.79 | 10.80 | 18.39 | 5.87 | 6.80 | 6.39 |
| Topo-LSTM | 8.45 | 15.80 | 25.42 | 8.51 | 12.68 | 13.68 |
| NDW | 15.21 | 28.23 | 32.30 | 12.41 | 13.23 | 14.30 |
| SNIDSA | 25.37 | 36.64 | 42.89 | 15.34 | 16.64 | 16.89 |
| FOREST | 30.35 | 41.76 | 48.46 | 22.38 | 22.90 | 23.00 |
| Inf-VAE | 14.85 | 32.72 | 45.72 | 19.80 | 20.66 | 21.32 |
| DyHGCN | 31.71 | 46.93 | 56.12 | 20.35 | 21.04 | 21.17 |
| MS-HGAT | 32.40 | 47.90 | 57.39 | 20.16 | 20.86 | 20.99 |
| This model | 41.20 | 56.20 | 63.44 | 29.13 | 29.84 | 29.95 |

TABLE 3
Experimental results on the Douban dataset

| | Douban | | | | | |
|---|---|---|---|---|---|---|
| Model | Hits@10 | Hits@50 | Hits@100 | MAP@10 | MAP@50 | MAP@100 |
| DeepDiffuse | 9.02 | 14.93 | 19.13 | 6.02 | 6.93 | 7.13 |
| Topo-LSTM | 8.57 | 16.53 | 21.47 | 6.57 | 7.53 | 7.78 |
| NDW | 10.00 | 21.13 | 30.14 | 8.24 | 8.73 | 9.14 |
| SNIDSA | 16.23 | 27.24 | 35.59 | 10.02 | 11.24 | 11.59 |
| FOREST | 18.20 | 29.73 | 36.32 | 10.52 | 11.02 | 11.11 |
| Inf-VAE | 8.94 | 22.02 | 35.72 | 11.02 | 11.28 | 12.28 |
| DyHGCN | 20.08 | 33.05 | 40.37 | 11.49 | 12.19 | 12.08 |
| MS-HGAT | 22.31 | 36.70 | 44.34 | 11.93 | 12.61 | 12.72 |
| This model | 42.04 | 54.99 | 60.63 | 30.76 | 31.45 | 31.38 |

TABLE 4
Experimental results on the Android dataset

| | Android | | | | | |
|---|---|---|---|---|---|---|
| Model | Hits@10 | Hits@50 | Hits@100 | MAP@10 | MAP@50 | MAP@100 |
| DeepDiffuse | 4.13 | 10.58 | 17.21 | 2.30 | 2.53 | 2.56 |
| Topo-LSTM | 4.56 | 12.63 | 16.53 | 3.60 | 4.05 | 4.06 |
| NDW | 4.85 | 14.24 | 18.97 | 2.01 | 2.22 | 2.93 |
| SNIDSA | 5.63 | 15.22 | 20.93 | 2.98 | 3.24 | 3.97 |
| FOREST | 8.89 | 16.61 | 23.74 | 6.01 | 6.35 | 6.45 |
| Inf-VAE | 5.98 | 14.70 | 20.91 | 4.82 | 4.86 | 5.27 |
| DyHGCN | 10.05 | 20.03 | 27.09 | 6.18 | 6.60 | 6.69 |
| MS-HGAT | 10.12 | 19.57 | 27.47 | 6.42 | 6.84 | 6.96 |
| This model | 10.43 | 21.31 | 28.84 | 6.72 | 7.16 | 7.27 |

TABLE 5
Experimental results on the Christianity dataset

| | Christianity | | | | | |
|---|---|---|---|---|---|---|
| Model | Hits@10 | Hits@50 | Hits@100 | MAP@10 | MAP@50 | MAP@100 |
| DeepDiffuse | 10.27 | 21.83 | 30.74 | 7.27 | 7.83 | 7.84 |
| Topo-LSTM | 12.28 | 22.63 | 31.52 | 7.93 | 8.67 | 9.86 |
| NDW | 15.41 | 31.36 | 45.86 | 7.41 | 7.68 | 7.86 |
| SNIDSA | 17.74 | 34.58 | 48.76 | 8.69 | 8.94 | 9.72 |
| FOREST | 23.87 | 40.43 | 51.28 | 14.80 | 15.48 | 15.62 |
| Inf-VAE | 18.38 | 38.50 | 51.05 | 9.25 | 11.96 | 12.45 |
| DyHGCN | 27.02 | 44.18 | 54.24 | 16.73 | 17.72 | 17.57 |
| MS-HGAT | 29.59 | 46.15 | 54.64 | 17.53 | 18.28 | 18.40 |
| This model | 29.19 | 46.54 | 57.19 | 18.56 | 19.52 | 19.37 |

To evaluate the contribution of each module of the present disclosure, the following ablation studies were performed on different parts of this model:
w/oEDGNN: the hypergraph neural network based on equivariant diffusion was replaced with the hypergraph neural network.
w/o CA: the co-attention mechanism was replaced with a gating fusion strategy.
w/o UE: user embeddings are ignored.
w/o CE: cascade embeddings are ignored.

By observation of tables 6 and 7, this model exhibited good rationality. First, it was observed that the prediction performance dropped significantly when the user embeddings captured by the social relationship graph were removed. This indicated the impact of user features on the effectiveness of the prediction model in the social network. Also, removing the cascade embeddings extracted from the propagation cascade hypergraph also resulted in a significant decline of the prediction performance, further demonstrating the effectiveness of integrating two feature representations. Moreover, when the hypergraph neural network based on equivariant diffusion was replaced with the hypergraph neural network, it could be noted that the prediction performance dropped significantly on the Twitter and Douban datasets, and a slight drop was observed on the Android and Christianity datasets. Considering the relatively sparse cascade information in the Android and Christianity datasets, it reflects that the hypergraph neural network based on equivariant diffusion can comprehensively learn the internal and external influences of the cascade information, such that the prediction performance can be better enhanced when the hypergraph neural network based on equivariant diffusion processes complex cascade information datasets. Finally, a significant drop in prediction performance was observed after removal of the co-attention fusion module, particularly on the Twitter and Douban datasets. This indicates that introducing a co-attention mechanism can better fuse user features and cascade features when the quality of cascade embeddings is high.

TABLE 6
Ablation experiments on the Twitter and Douban datasets

| | Twitter | | Douban | |
|---|---|---|---|---|
| Model | Hits@100 | MAP@100 | Hits@100 | MAP@100 |
| This model | 63.44 | 29.95 | 60.63 | 31.38 |
| w/o EDGNN | 60.34 | 26.55 | 58.59 | 29.79 |
| w/o CA | 58.15 | 21.97 | 42.23 | 13.32 |
| w/o UE | 49.79 | 11.36 | 43.61 | 12.94 |
| w/o CE | 58.15 | 21.97 | 42.23 | 12.32 |

TABLE 7
Ablation experiments on the Android and Christianity datasets

| | Android | | Christianity | |
|---|---|---|---|---|
| Model | Hits@100 | MAP@100 | Hits@100 | MAP@100 |
| This model | 28.84 | 7.27 | 57.19 | 19.37 |
| w/o EDGNN | 26.81 | 6.82 | 56.21 | 18.14 |
| w/o CA | 27.55 | 6.93 | 54.83 | 18.19 |
| w/o UE | 28.14 | 6.94 | 55.62 | 18.02 |
| w/o CE | 27.54 | 6.93 | 55.23 | 17.24 |

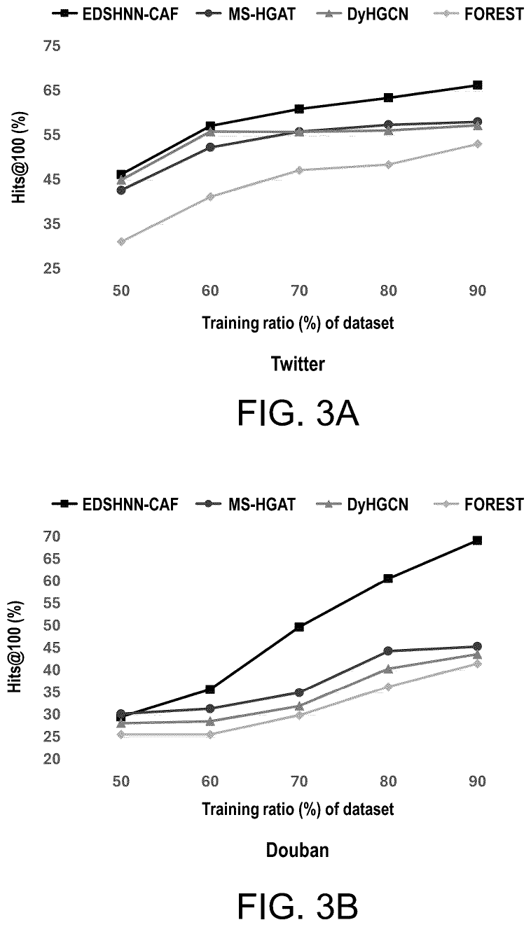

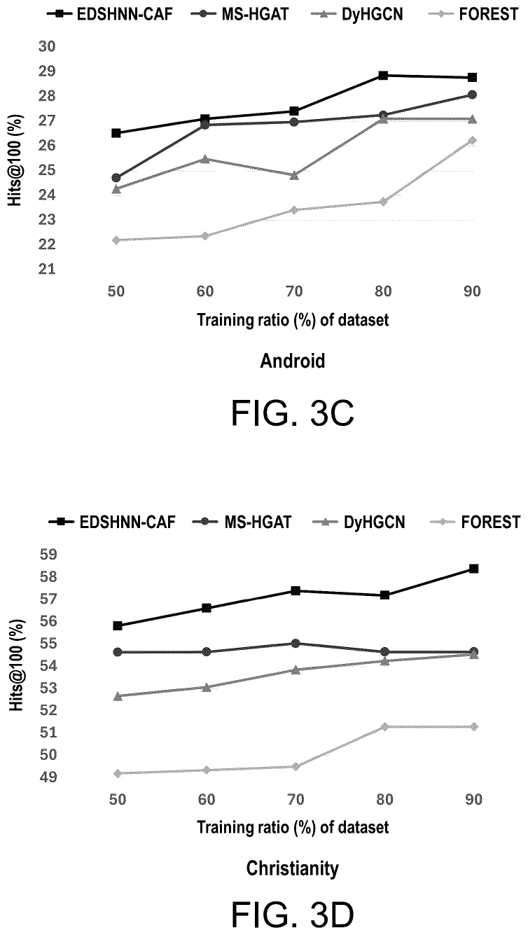

In the field of information propagation prediction, an outstanding propagation prediction model has to exhibit stable and excellent performance on datasets of different quality. Therefore, in the present disclosure, a series of comparative experiments were carried out on four datasets with different training ratios to strictly evaluate the effectiveness and progress of this model. As shown in FIG. 3A-FIG. 3D, the experimental results show that this model was able to achieve comparable results using only 60% of the training data compared to the performance levels achieved by other models using 90% of the training data. It is worth noting that even when compared to the most advanced model MS-HGAT, this model, with 70% of the training data, can achieve similar results for MS-HGAT using 90% of the training data. This discovery not only highlights the overall advantages of the hypergraph neural network based on equivariant diffusion in the aspect of cascade feature extraction, but also emphasizes the efficiency of a co-attention mechanism in the aspect of the fusion of user embeddings and cascade embeddings.

1. An information propagation prediction method based on a sequential hypergraph neural network with co-attention fusion, comprising the following steps:
S1, user feature learning
constructing a social network graph according to known information concerned by user batches, and learning embedding representations
$${X}_{F}^{{L}_{F}}$$
of users by using a dual-layer graph convolutional network to obtain static representations
of all the users in consideration of a relatively stable structure of a social network of the users;
S2, cascade feature learning
constructing a propagation cascade graph by adopting a hypergraph, regarding propagation of each of pieces of information as hyperedges, considering characteristic that influences among the information are generally short-term correlation, decomposing previous cascades into a plurality of subsets based on timestamps, constructing the hypergraph according to each of the subsets, acquiring a cascade embedding of each of the subsets by using a hypergraph neural network based on equivariant diffusion, and connecting cascade embeddings of different timestamps by means of a gated residual mechanism; and
S3, feature fusion and prediction
firstly, aligning a time
$${t}_{i}^{m}$$
when a user uᵢ propagates the information with a pre-stored timestamp, then retrieving relevant cascade embedding to obtain C_{D}=[(h_{e,t})]∈R^{|c}^{ₘ}^{|×d}, t=1, 2, . . . , T, wherein h_{e,t} is the cascade embeddings obtained at the different timestamps in the S2, then stacking two co-attention layers, and learning an interdependence between cascade features and user features by means of a co-attention mechanism, so as to capture a complex relationship and interaction between the cascade features and the user features, and then calculating a possibility of potential user infection,
wherein the feature fusion in the S3 is progressive, with an output of each layer being used as an input of a next layer;
in a first co-attention layer, a user embedding
$${X}_{F}^{{L}_{F}}$$
and a cascade embedding C_{D} are combined to generate a fusion embedding
$${R}_{CA}^{( 1 )} ;$$
then, in a second co-attention layer, C_{D} and
$${R}_{CA}^{( 1 )}$$
are combined to generate a final fusion R_{CA} to further enhance the fusion; an output vector of each of the co-attention layers is d-dimensional;
the following is a calculation process for the first co-attention layer:
$${R}_{{CA}_{X ← C}} = {X}_{F}^{LF} + MA ( {X}_{F}^{{L}_{F}} , {C}_{D} , {C}_{D} )$$
$${R}_{{CA}_{X ← C}^{′}} = {R}_{{CA}_{X ← C}} + FFN ( {R}_{{CA}_{X ← C}} ) )$$
$${R}_{{CA}_{C ← X}} = {C}_{D} + MA ( {C}_{D} , {X}_{F}^{LF} , {X}_{F}^{LF} )$$
$${R}_{{CA}_{C ← X}^{′}} = {R}_{{CA}_{C ← X}} + FFN ( {R}_{{CA}_{C ← X}} )$$
$${R}_{CA}^{( 1 )} = ( {R}_{{CA}_{X ← C}^{′}} ⊕ {R}_{{CA}_{C ← X}^{′}} ) {W}_{CA}^{( 1 )}$$
R_{CA}_{_{X←C}} represents a result of the user embedding after being processed by the co-attention mechanism, and MA represents the attention mechanism considering the influence of the cascade embedding C_{D} in the user embedding
$${X}_{F}^{LF} ; {R}_{{CA}_{X ← C}^{′}}$$
represents a result of applying a feedforward neural network to an output of R_{CA}_{_{X←C}}, and FFN is the feedforward neural network used to enhance nonlinearity and capability to capture complex modes; R_{CA}_{_{C←X}} represents a result of the cascade embedding after being processed by the co-attention mechanism considering the influence of the user embedding
$${X}_{F}^{LF}$$
in the cascade embedding C_{D}: R_{CA′}_{_{C←X}} is a result of applying the feedforward neural network to an output of
$${R}_{{CA}_{C ← X}} ; {R}_{CA}^{( 1 )}$$
is a final output of the first co-attention layer and will be passed to a next co-attention layer:
$${W}_{CA}^{( 1 )}$$
∈ [symbol] ^{2d×d} is a projection matrix of the first co-attention layer, ⊕ represents a concatenation of vectors, and
$${R}_{CA}^{( 1 )}$$
is converted into a d+1-dimensional representation before being input to a next CA layer.

2. The information propagation prediction method based on the sequential hypergraph neural network with the co-attention fusion according to claim 1, wherein in the user feature learning, a layer-by-layer propagation rule of a graph convolutional network is:
$${X}_{F}^{l + 1} = σ ( {- \frac{1}{2}}^{} {- \frac{1}{2}}^{} {X}_{F}^{l} {W}_{F} )$$
wherein, W_{F} is a trainable weight matrix, and [symbol] =A_{F}+I and [symbol] are an adjacency matrix and a degree matrix of a self-loop social network graph G_{F}, respectively.

3. The information propagation prediction method based on the sequential hypergraph neural network with the co-attention fusion according to claim 1, wherein the S2 comprises constructing the hypergraph neural network based on the equivariant diffusion, specifically comprising:
(1) Nodes to the hyperedges
for each of the nodes on the hypergraph, firstly, transforming a node feature of the nodes by means of a multilayer perceptron, and then gathering the node feature to an associated hyperedge to obtain a hyperedge representation
$${m}_{e}^{l + 1} ,$$
and a specific form is as follows:
$${m}_{u \to e}^{l + 1} = \hat{ϕ} ( {h}_{v , t}^{l} )$$
$${m}_{u \to e}^{l + 1} = {\sum }_{u ∈ e} {m}_{u \to e}^{l + 1}$$
wherein, \hat{φ} is the multilayer perceptron, the multilayer perceptron in a model shares parameters,
$${m}_{u \to e}^{l + 1}$$
is information from a node u to a hyperedge e,
$${h}_{v , t}^{l}$$
is the node feature, and
$${h}_{v , t}^{0} = {X}_{F}^{LF}$$
an initial feature
(2) The hyperedges to the nodes broadcasting the hyperedge representation
$${m}_{e}^{l + 1}$$
to a related node, and calculating information
$${m}_{e \to u}^{l + 1}$$
from the hyperedges to the nodes by means of a multilayer perceptron, wherein \hat{ρ} is the multilayer perceptron:
$${m}_{e \to u}^{l + 1} = \hat{ρ} ( {h}_{v , t}^{l} , {m}_{e}^{l + 1} )$$
(3) Node feature updating
for each of the nodes on the hypergraph, updating a feature
$${h}_{v , t}^{l + 1}$$
of the nodes by using the multilayer perceptron, and a representation is as follows:
$${h}_{v , t}^{l + 1} = \hat{φ} ( {h}_{v , t}^{l} , {\sum }_{e : u ∈ e} {m}_{e \to u ,}^{l + 1} {X}_{F}^{{L}_{F}} , {d}_{v} )$$
wherein, \hat{φ} is the multilayer perceptron, and dᵥ represents degree information of the nodes;
(4) Hyperedge feature updating for each of the hyperedges, aggregating an updated node feature into the hyperedges, and then updating a hyperedge feature
$${h}_{e , t}^{l + 1}$$
by using a multilayer perceptron \hat{ψ}, and a specific form is as follows:
$${h}_{e , t}^{l + 1} = \hat{ψ} ( {\sum }_{u : e ∈ u} {h}_{v , t}^{l + 1} ) .$$

4. The information propagation prediction method based on the sequential hypergraph neural network with the co-attention fusion according to claim 1, wherein the S2 comprises introducing the gated residual mechanism to achieve propagation of residual information between the different timestamps, and a mechanism generates an initial embedding of each of nodes by combining a dynamic embedding and a user embedding of the nodes for each time period, comprising the following calculation:
the initial embedding of the nodes at a timestamp t+1 can be calculated as follows:
$${h}_{v , t + 1}^{0} = g {h}_{v , t}^{{L}_{D}} + ( 1 - g ) {X}_{F}^{{L}_{F}} , g = \frac{{e}^{{Z}_{R}^{T} σ ( {W}_{R} {h}_{v , t}^{{L}_{D}} )}}{{e}^{{Z}_{R}^{T} σ ( {W}_{R} {h}_{v , t}^{{L}_{D}} )} + {e}^{{Z}_{R}^{T} σ ( {W}_{R} {X}_{F}^{{L}_{F}} )}}$$
wherein, W_{R} and z_{R} represent a transformation matrix and a vector of a gating mechanism, respectively, σ(·) represents a tanh function, a user representation
$${X}_{F}^{{L}_{F}}$$
learned from a user feature learning module is used as an initial embedding of the user,
$${h}_{v , t}^{{L}_{D}}$$
represents a hypergraph node feature obtained by the hypergraph neural network based on the equivariant diffusion, and a value g calculated by a gating function is used to control a percentage of the residual information retained, and the hypergraphs are sequentially connected by the gated residual mechanism.

5. (canceled)

6. The information propagation prediction method based on the sequential hypergraph neural network with the co-attention fusion according to claim 1, wherein the feature fusion and prediction in the S3 comprise calculating a diffusion probability of the users by means of the following method:
$$\hat{y} = softmax ( {W}_{p} {R}_{CA} + {Mask}_{m} )$$
wherein, Wₚ is a transformation matrix that maps R_{CA} to a user-specific space, Maskₘ is used to mask the users that have been activated before the prediction, if the user uᵢ participates in a cascade cₘ in a step j,
$${( {Mask}_{m} )}_{1 , i}^{j , i} = 0 , and {( {Mask}_{m} )}_{j + 1 , i}^{\vert {c}_{m} \vert , i} = - ∞ ,$$
and training is carried out by adopting cross-entropy loss:
$$𝒥 ( θ ) = - {\sum }_{j = 2}^{\vert {c}_{m} \vert} {\sum }_{i = 1}^{\vert U \vert} {y}_{j i} log ( {\hat{y}}_{j i} )$$
wherein, θ represents all parameters that need to be learned in a model, and if the user uᵢ participates in the cascade cₘ in the step j, then yⱼᵢ=1, or otherwise, yⱼᵢ=0.

7. The information propagation prediction method based on the sequential hypergraph neural network with the co-attention fusion according to claim 1, comprising:
a user feature learning module acquiring a user embedding by using a graph convolutional neural network;
a cascade feature learning module configured to acquire a cascade embedding of internal and external features of an encapsulated cascade structure; and
a feature fusion and prediction module acquiring fusion features of the cascade embedding and the user embedding by using a cascade embedding query process and a dual-layer co-attention mechanism and then calculating a possibility of potential user propagation.

8. The information propagation prediction method based on the sequential hypergraph neural network with the co-attention fusion according to claim 7, wherein the feature fusion and prediction module in the method comprises a feature fusion layer and propagation prediction, wherein the feature fusion layer comprises the cascade embedding query process and the dual-layer co-attention mechanism, and information leakage is avoided by carefully selecting a pre-engagement embedding; a co-attention layer has user-to-cascade and cascade-to-user attention flows, achieves fine integration of user preference and cascade dynamics, and utilizes an interdependence between the user preference and the cascade dynamics to enhance a prediction capability of the model.

9. The information propagation prediction method based on the sequential hypergraph neural network with the co-attention fusion according to claim 8, wherein in the cascade embedding query process, for a given target cascade, a representation of the cascade is read in a latest time interval before user participates in the cascade, so as to reduce a risk of information leakage, and the process needs to align the time
$${t}_{i}^{m}$$
when the user uᵢ propagates the information with the pre-stored timestamp, and then the relevant cascade embedding is retrieved to obtain C_{D}=[(h_{e,t})]∈R^{|c}^{ₘ}^{|×d}, t=1, 2, . . . , T, wherein h_{e,t} represents the cascade embeddings obtained at the different timestamps in the S2;
a co-attention block is operated by utilizing queries from one modality and keys and values from another modality, and a query matrix serves as residual information after a multi-head attention sublayer.

10. The information propagation prediction method based on the sequential hypergraph neural network with the co-attention fusion according to claim 4, wherein the feature fusion and prediction in the S3 comprise calculating a diffusion probability of the users by means of the following method:
$$\hat{y} = softmax ( {W}_{p} {R}_{CA} + {Mask}_{m} )$$
wherein, Wₚ is a transformation matrix that maps R_{CA} to a user-specific space, Maskₘ is used to mask the users that have been activated before the prediction, if the user uᵢ participates in a cascade cₘ in a step j,
$${( {Mask}_{m} )}_{1 , i}^{j , i} = 0 , and {( {Mask}_{m} )}_{j + 1 , i}^{\vert {c}_{m} \vert , i} = - ∞ ,$$
and training is carried out by adopting cross-entropy loss:
$$𝒥 ( θ ) = - {\sum }_{j = 2}^{\vert {c}_{m} \vert} {\sum }_{i = 1}^{\vert U \vert} {y}_{j i} log ( {\hat{y}}_{j i} )$$
wherein, θ represents all parameters that need to be learned in a model, and if the user uᵢ participates in the cascade cₘ in the step j, then yⱼᵢ=1, or otherwise, yⱼᵢ=0.
